(19) United States
(12) Patent Application Publication
(10) Pub. No.: US 2007/0126907 A1
(43) Pub. Date: Jun. 7, 2007

(54) Electronic viewfinder device for photographic apparatus and film cameras

(76) Inventor: Gerd Stueckler, Tegernsee (DE)

Correspondence Address: LATHROP & GAGE LC, 4845 PEARL EAST CIRCLE, SUITE 300, BOULDER, CO, 80301, US

(21) Appl. No.: 11/446,074

(22) Filed: Jun. 2, 2006

(30) Foreign Application Priority Data
Jun. 3, 2005 (DE) 10 2005 025 613.9

(51) Int. Cl. H04N 5/222

(52) U.S. Cl. 348/333.01

(57) ABSTRACT

An electronic viewfinder device has two or more electronic displays that produce display images. The display images represent different areas of an image captured by the image sensor of a camera with which the electronic viewfinder is being employed. The display images are combined by optical means to form a viewfinder image, which consists of at least two images on the same scale and represents a view of the image captured by the image sensor of the camera.

### RELATED APPLICATIONS

This application claims priority to German Patent Application 10 2005 025 613.9 filed Jun. 3, 2005, the disclosure of which is incorporated by reference.

### TECHNICAL FIELD

The present invention relates to an electronic viewfinder device having a display for showing an image captured by an image sensor of a camera. In particular, the viewfinder device is such that it allows the user to judge the sharpness and the depth of focus of the captured image. Additionally, the viewfinder device is available with a viewfinder eyepiece or a viewfinder monitor for photo, film and video cameras, and it allows the user to control the image which is to be recorded, and to analyze and monitor the color, brightness and contrast.

### BACKGROUND

In cameras, etc., which do not use an optical viewfinder, it is expedient to use a small electronic viewfinder/monitor which enables the user to judge the image, and at the same time, extract color, brightness, contrast, sharpness and depth of focus. In order to do this, the viewfinder must be capable of displaying the entire image resolution of the picture format used. Only then can the sharpness and depth of focus of the image to be analyzed (evaluated) and, hence, the correct distance and shutter for the desired depth of focus may be selected. Only then is it possible to tell while a picture is being taken, whether, and in which direction, the distance is to be adjusted.

There are a number of different solutions already known in the prior art but they provide only a partial solution to the problems stated.

There are already small electronic image generators such as, for example, DLP's (Digital Light Processing) or special LCD's (Liquid Crystal Display), which are capable of displaying an image made up of 2 million color pixels. However, until now, they have not been used for electronic viewfinders, due to their very high cost. Therefore, monitors and viewfinders are used which contain cheap, small displays, that have relatively poor resolution. Practically every video camera has a viewfinder of this kind. In these viewfinders, the image is produced with relatively low resolution, and can be magnified for viewing by the cameraman through an eyepiece, while being well protected against extraneous light and, thus, allowing a good assessment of the image section, color, brightness and contrast, but, not a precise evaluation of the sharpness and depth of focus. In high definition (HD) cameras, in particular, with a format of 1.280×720 or 1.920×1.080 pixels, the displays of the electronic viewfinders show the images with a lower resolution, but often do not display the entire image captured, and often show it only in black and white.

In professional carmeras, a black and white LCD (Liquid Crystal Display) or a black and white picture tube are normally used, as they always have a higher resolution than color LCD's of the same size. Accordingly, it is not possible to judge the color.

Therefore, various aids are currently used for assessing focus. There are aids in which the image to be assessed can be displayed in a magnified view in the viewfinder by operating a key. However, this has the disadvantage that only a small part of the image is displayed and, therefore, the entire view is lost. Moreover, the sharpness of focus cannot be judged during a shot in progress, as the cameraman generally has to observe the entire image section being recorded. During this shot in progress, the cameraman cannot continuously switch this aid on and off.

Furthermore, there is an aid which particularly emphasises the contours of those parts of the image in the viewfinder, which are determined by the electronics as being sections in focus. While this is very helpful for adjusting distance to a specific object, there is the disadvantage that the depth of focus of the shot cannot be judged by this aid device.

### SUMMARY

The present invention provides a compact and inexpensive electronic viewfinder or monitor (an electronic viewfinder device), which allows the image section, color, brightness, contrast and sharpness and depth of focus to be evaluated simultaneously and comprehensively as far as possible. In particular, in one embodiment, the evaluation of sharpness and depth of focus should also be possible for the above mentioned High Definition (HD) cameras with a resolution of about 2 million pixels, at least in part of the viewfinder image. A further object of this invention is based on the problem of providing an electronic viewfinder device, which uses as little current as possible.

Advantageous embodiments of the invention will become apparent from the claims and the description that follows.

According to the invention, two or more electronic displays are provided, that produce display images, representing different areas of the image, or main image captured by the image sensor of the camera. The display images are combined by optical means to form a viewfinder image, which consists of at least two images on the same scale and represents a view of an image (the main image) captured by the image sensor of the camera.

Instead of the use of a single display for the viewfinder device to produce a viewfinder image, as has previously been conventional, the invention uses two or more displays, the images of which (display images) are combined to form a viewfinder image. This combination can be carried out in the form of overlapping or cross-fading images, or in the form of an addition of (display) images to one another. Instead of directly combining display images, it is also possible to use virtual images of these display images, i.e., images of display images generated by an optical device. It is essential that the combined or composite images have the same scale in order to display the image captured by the image sensor of the camera in a manner which is true to the actual image being captured by the camera.

Hereinafter the terms “electronic viewfinder device”, “viewfinder” and “monitor” are used as equivalents to one another.

In another embodiment of the invention, two displays are provided, for example, showing different halves of the image captured by the image sensor of the camera. By combining the images of these displays, by the optical means being precisely positioned along boundary lines of the displays, the two halves are recombined to form a unified viewfinder image. This viewfinder image represents the image captured by the image sensor of the camera. As smaller displays are fundamentally easier and less expensive to produce than larger displays, this embodiment of the invention has the advantage that the corresponding viewfinder device allows the image captured to be analyzed with the maximum possible resolution, while being relatively inexpensive to manufacture.

In another embodiment of the invention, the viewfinder image consists of at least two images of different pixel density. For example, the part of the image which is of interest, typically the center of the image, is displayed by means of a first, correspondingly small display in high-resolution, while the image as a whole is displayed using a display which is (metrically) correspondingly larger than the first display, but which has a lower pixel density (number of pixels in the horizontal and vertical directions per unit of length).

In the aforementioned embodiment, instead of the display of larger dimensions which shows the overall image or main image captured by the image sensor of the camera in low resolution, and instead of the display of smaller dimensions which shows only the center of the image, for example, in high-resolution, it is also possible to use two displays of similar or identical size. For example, the first display can show an image section (e.g., the center of the image) in a highly resolved form. The second display would then show the entire image captured by the image sensor of the camera. This image is then optically magnified to the same scale as the smaller image, and the virtual image produced is combined or superimposed on the image of the first display, to form a viewfinder image. As a result of the optically enlarged representation, an image is obtained which is equivalent to a correspondingly larger display image with a correspondingly reduced resolution.

By combining the image section shown, consisting of at least two images of different pixel density, it is possible to keep the total number of display pixels used substantially lower than, for example, the more than 2 million color pixels used in HD cameras. This can be done while still showing a wide area, e.g., 50%, of the total image width and height with full HD sharpness, while showing the remainder of the image with reduced sharpness. However, as a rule, even very low sharpness is sufficient to enable the colors of the image to be judged. Accordingly, it is possible to inexpensively produce a viewfinder and to judge and adjust the sharpness and depth of focus as well as the image contrast precisely with a viewfinder of this kind in the area in question. Also, the color and brightness of the image can be adjusted for accuracy.

Suitable optical means for combining the display images or representations obtained therefrom include, optical relays, that include, in particular, partially transparent mirrors, beam splitter prisms or other optical means suitable for this purpose. The image, thus combined or superimposed, is generally viewed by the user through a viewfinder eyepiece of the viewfinder device.

The display images may be black and white or colored. Thus, black and white and/or colored images may be combined to form a viewfinder image. As the human eye has lower resolution for color focusing than for black and white focusing, it is expedient to display the high-resolution part of the viewfinder image which is of interest in black and white and to display the remaining area in color, for example, so that on the one hand, the focus and depth of focus can be judged, and on the other hand, the color impression can also be judged sufficiently.

With an electronic viewfinder device according to an embodiment of the invention, it is useful if individual and/or overlapping areas of the viewfinder image, composed of at least two images, can be regulated. This is typically done by adjusting the associated display or displays in terms of at least one of the image parameters. These parameters typically include the brightness component, the color component and the contrast.

The images of the individual displays are frequently different in their brightness, color distribution and contrast, and are combined to form a unified viewfinder image. In order to obtain as homogeneous a viewfinder image as possible, it is typical to match the individual display images for brightness, color and contrast, such that the overall viewfinder image is largely homogeneous in terms of these parameters.

Adjustability of the above mentioned image parameters may be useful, in particular, for overlapping areas. Here, it is frequently useful to leave the image with high-resolution in the overlapping area uninfluenced by the superimposed image of lower resolution, so as not to reduce the contrast in the high-resolution image, for example. For this reason, it is advisable for the display with the lower resolution in the overlapping image area to be adjustable to the point where the resolution turns black.

The image parameters to be regulated can be prescribed by the equipment control or by the user.

For example, it is also useful if a color display (of lower resolution) in the area of overlap with a black and white image (of higher resolution) displays only the color component without the brightness component. In the case of two black and white or two color images, one with a higher resolution and the other with a lower resolution, the image of lower resolution may be shown in black, for example, in the area of overlap.

The adjustment of the image parameters described above, such as the brightness component, color component or contrast, may also be carried out using the optical means which combine the images. Thus, the brightness component can be influenced by means of the corresponding transparency of the mirror. A black display (e.g., of an overlapping image area) can be achieved using an opaque shutter.

Another embodiment of the invention relates to the operation of an electronic viewfinder device which is as economical as possible, that utilizes electric current. An electronic viewfinder device of this kind has at least one display for showing an image captured by an image sensor of a camera and having a viewfinder eyepiece for studying the viewfinder image includes an automatic circuit. This circuit, coupled with at least one display and with a distance sensor, is such that, at minimum, one display (electronic display) is switched on (or activated) when the image is viewed through the viewfinder eyepiece.

The automatic circuit mentioned above contains a detector which detects a user looking through the viewfinder eyepiece. Detectors of this kind are known per se and may be, for example, infra red, radio or ultrasound sensors. Mechanical sensors are also suitable for this purpose if, for example, the intention is to detect contact of the viewfinder eyepiece with the use. If contact between the user and the viewfinder eyepiece is detected, the automatic circuit automatically switches on the display or displays (or activates the display or displays) available in the electronic viewfinder device. However, if a user is not looking through the eyepiece, the displays (electronic displays) switch to a sleep mode, which uses only minimal current.

It will be understood that the features of the electronic viewfinder device according to the invention as described above may be implemented not only in the combinations described but also individually and in other combinations.

### BRIEF DESCRIPTION OF THE DRAWINGS

Attention is now directed to the drawing figures where like numerals, letters and/or characters indicate corresponding or like components.

In the drawings:

FIG. 1 shows a schematic cross-sectional view of a first embodiment of an electronic viewfinder device according to the invention having two displays (FIG. 1A) and the viewfinder image resulting therefrom (FIG. 1B);

FIG. 2 shows a schematic cross-sectional view of a second embodiment of an electronic viewfinder device according to the invention having two displays (FIG. 2A) and the viewfinder image resulting therefrom (FIG. 2B);

FIG. 3 shows a schematic cross-sectional view of a third embodiment of an electronic viewfinder device according to the invention with two displays (FIG. 3A) and the viewfinder image resulting therefrom (FIG. 3B); and,

FIG. 4 shows an electronic viewfinder device with an automatic circuit for low-current operation of the available displays.

### DETAILED DESCRIPTION

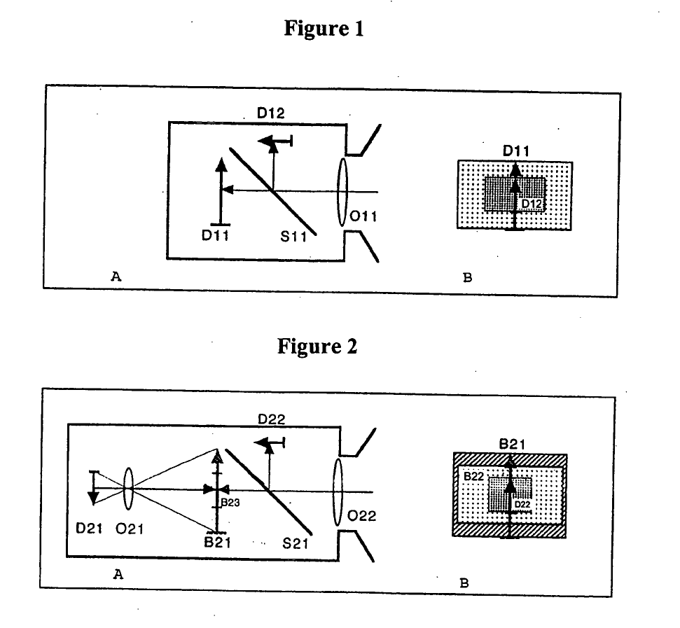

Preferred embodiments of the invention will now be described, referring to FIGS. 1 to 4. The embodiments shown in FIGS. 1 and 2 start from the premise that a High Definition (HD) image of a current HD standard consisting of 1920×1080 (about 2 million) pixels is to be displayed in the viewfinder. For an exact representation, a display of 1920×1080 blue/green/red pixels would be needed, i.e., with more than 6 million subpixels to be actuated individually.

In the embodiment of FIG. 1, two separate displays D11 and D12 are used, the images of which are superimposed by means of an optical relay, for example, including a partially transparent mirror S11. The superimposed image is viewed as one image by the user through the viewfinder eyepiece O11 (c.f., FIG. 1A). For the display D11, for example, a color display with 640(×3)×360 color pixels is used to display the entire HD image area or the display D12, a black and white display, which is (metrically) precisely half the size having 960×540 black and white pixels, is used to display the central HD image area. In the area of superimposition of the two display images, only the color of the color display D11 is shown, with no brightness information, and only the brightness information of the black and white display D12 is shown, thus displaying the entire HD image in color with at least 33% of the horizontal and vertical HD resolution. This resolution is generally sufficient to judge the color, brightness and contrast. The central part of the HD image, is displayed at 50% of the HD image width and height in the maximum possible brightness resolution (c.f., FIG. 1B), yielding the optimum representation of image sharpness and depth of focus.

In another embodiment, as shown in FIG. 2, two identical standard commercial color displays D21 and D22 are used, each having 852×600 pixels, for example, the images of which are optically superimposed using an optical relay, for example, including a partly transparent mirror. Each of the pixels consists of three blue/green/red subpixels and can therefore, represent any color. The pixels are arranged in the 15 μm frame over an image area of 12.78×9.0 mm.

The image of the display D21 is magnified, e.g., 2.5×(times), by means of the lens O21 (also typically includes as part of the optical relay), in the image plane B21, to the size of B21=31.95×22.5 mm. Every 2.5×2.5 pixels of the HD image of 1920×1080 pixels are then displayed as one pixel of the image of display D21, so that the HD image is in the form of 768×432 color pixels and has a size of B22=28.8×16.2 mm in the image plane B21.

The display D21 preferably images every individual one of the 852×600 pixels located around the center of the HD image, to a size of D22=12.78×9.0 mm.

The images D22 and B21 are optically superimposed by means of the partially transparent mirror S21, and preferably, in such a way that image D22 appears in the center of image B21. The transparency of the mirror S21 is selected so that the reduction in light density of the image B21, caused by the magnification of an image from the display D21, is compensated. The central area of the image B21 is preferably covered with a shutter B23 of the size D22=12.78×9.0 mm in order to increase the contrast, as this area of an image D22 is displayed. Then, both images are viewable through the eyepiece O22 as one large image B22, with an image width of e.g., 40° (c.f., FIG. 2).

The area outside the 768×432 pixels of the display D21, which is not used for the image representation (c.f., FIG. 2B), is preferably used to display the shutter, filter, distance, sound level, etc., and especially, to display a grey scale arrow-type indicator and a black HD image border as a reference for the black level. Although there is a small contrast in the scope of the displays used, it is easy and simple to assess (evaluate or analyze) the brightness and contrast of the HD image.

With this viewfinder, in the important central image area, at 44% of the HD image widths, and 56% of the HD image height, the HD image is displayed in color with the maximum possible sharpness, so that the color, contrast, brightness, and particularly, the sharpness and depth of focus can be evaluated to an optimum degree. Over the remaining area, the HD image is displayed with only 40% of the HD image sharpness. This allows for a suitable analysis of the color, brightness and contrast.

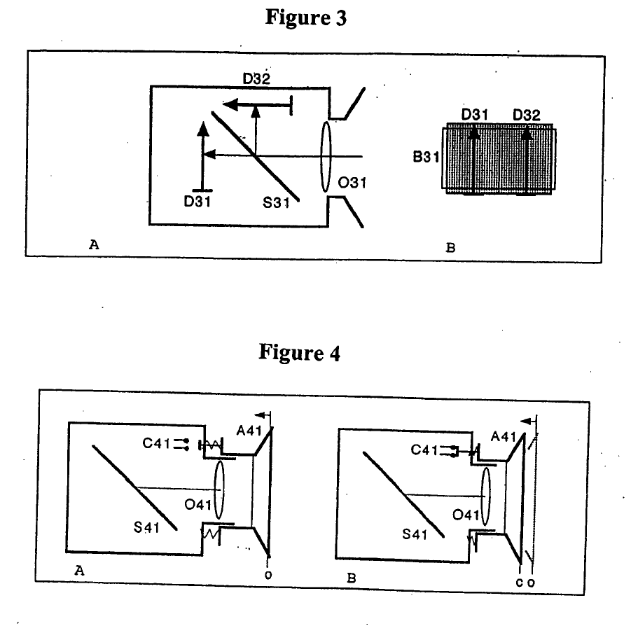

In another embodiment, according to FIG. 3, in order to display, for example, the lower HD image standard B31 of 1280×720 pixels, two standard commercial identical displays D31 and D32 are shown. These displays D31, D32 include, for example, 600×852 color pixels and are optically superimposed on an edge through an optical relay, for example, including a 50% transparent mirror S31 so that they can be viewed side by side without transition, and are seen as of equal brightness, as a single image of 1200×852 color pixels, through the eyepiece O31. In the area of 1200×720 pixels, the HD image is displayed, and over the remaining area, additional information may be placed in, as described in the above example. The total visible HD image of this lower HD standard is thus displayed with the maximum possible brightness and sharpness of color, although there is the disadvantage that on the left and right, 3% of the width of the HD image cannot be displayed. However, two of these standard commercial displays are considerably less expensive than a single display with twice the number of pixels.

The arrangement of two identical displays D31, D32 may also be used as a substitute for the display D22 in FIG. 2. This is done to achieve an even larger central area with full image sharpness, so that its size is increased from 852×600 pixels to 1200×852 pixels, for example.

FIG. 4 schematically shows in cross-section an electronic viewfinder device with an automatic circuit for low-voltage operation of the available displays.

In the embodiment shown in FIG. 4, the viewfinder eyepiece is designated O41. A partially transparent, for example, a semitransparent mirror S41, serves as an optical means or optical relay for combining the viewfinder images from one or more display images. Different embodiments of display image arrangements have already been discussed in detail in connection with FIGS. 1 to 3, and are applicable to, and may also be used, in FIG. 4. It should be mentioned in this context that the construction shown in FIG. 4 regarding the automatic circuit for the low-voltage operation of any displays available can also be used when there is only one display, including the single display devices of a conventional viewfinder device (described above).

A41 denotes the eyepiece casing, generally consisting of plastics, with an integrated distance sensor, against which the user presses his eye in looking through the eyepiece. FIG. 4A shows the position of the eyepiece when not in use (resting position). The right-hand outer edge of the eyepiece casing A41 is in the “zero” (“0”) position. As can be seen from FIG. 4A, a bridge for an electric switch is mounted on the opposite end of the eyepiece casing A41, and this switch moves as the eyepiece casing A41 moves.

If a user now observes the viewfinder image, the eyepiece casing A41 is moved from the resting position into the “C” position (c.f., FIG. 4B). This movement causes a corresponding deflection of the bridge element mentioned above, thereby closing the circuit C4 1. The circuit C41 is connected to the power supply and to the display or displays. Consequently a display (or a number of displays) is only operated when a user observes the viewfinder image. This ensures low-voltage operation of the electronic viewfinder device.

Naturally, other contactless distance sensors are also possible in which, for example, the proximity of a user to the eyepiece can be detected by radio, infra red or ultrasound sensors. On detection of the viewing of the viewfinder image by a user, a sensor of this kind is able to close the circuit C41 shown in FIG. 4, for example, providing a power supply for the displays.

1. A viewfinder device for displaying an image captured by an image sensor of a camera, comprising:
at least two electronic displays, each of the electronic displays producing display images of a portion of a main image captured by the image sensor of the camera, wherein each portion is different from any other portion produced by the electronic displays; and,
an optical relay for transforming the display images into at least two images of at least approximately the same scale and corresponding to a view of the main image captured by the image sensor of the camera, and for positioning the at least two images to be viewable as a unitary image, the at least two images defining a viewfinder image.

2. The viewfinder device of claim 1, wherein the viewfinder image includes at least two images of different pixel densities.

3. The viewfinder device of claim 2, wherein the viewfinder image includes at least two images of the same size.

4. The viewfinder device of claim 3, wherein the viewfinder image includes at least two black and white images.

5. The viewfinder device of claim 3, wherein the viewfinder image includes at least two color images.

6. The viewfinder device of claim 3, wherein the viewfinder image includes at least one black and white image and one color image.

7. The viewfinder device of claim 1, additionally comprising:
means for regulating at least one of the at least two electronic displays to adjust the viewfinder image by regulating at least one image parameter selected from the group consisting of the brightness component, the color component, and contrast.

8. The viewfinder device of claim 1, additionally comprising:
means for regulating the optical relay to adjust the viewfinder image by regulating at least one image parameter selected from the group consisting of the brightness component, the color component, and contrast.

9. The viewfinder device of claim 1, additionally comprising:
an eyepiece for viewing the viewfinder image;
at least one distance sensor; and,
an electronic circuit operatively coupled to at least one electronic display and the at least one distance sensor, for activating the electronic display when the viewfinder image is observed through the eyepiece.

10. The viewfinder device of claim 1, wherein at least two electronic displays include two electronic displays.

11. The viewfinder device of claim 1, wherein the optical relay includes a first component selected from the group consisting of partially transparent mirrors and beam splitting prisms.

12. The viewfinder device of claim 11, wherein the optical relay includes a second component, comprising a lens in operative communication with the first component.

13. The viewfinder device of claim 1, wherein the optical relay for positioning the at least two images is configured for superimposing the at least two images.
